(19) United States
(12) Patent Application Publication
(10) Pub. No.: US 2024/0011510 A1
(43) Pub. Date: Jan. 11, 2024

(54) PISTON ACCUMULATOR

(71) Applicant: HYDAC TECHNOLOGY GMBH, Sulzbach/Saar (DE)

(72) Inventors: Peter KLOFT, Ransbach-Baumbach (DE); Jens Holger KÖHNE, Saarbrücken (DE)

(21) Appl. No.: 18/022,354

(22) PCT Filed: Aug. 11, 2021
(86) PCT No.: PCT/EP2021/072413

§ 371 Date: Feb. 21, 2023

(30) Foreign Application Priority Data
Aug. 27, 2020 (DE) 10 2020 005 257.6

(51) Int. Cl. F15B 1/24

(52) U.S. Cl. CPC F15B 1/24; F15B 2201/31

(57) ABSTRACT

Disclosed is a piston accumulator having an accumulator housing (10) and a separator piston (12), which can be moved longitudinally in the accumulator housing (10) and separates two media spaces (14, 16) from each other, which is characterized in that an end-position cushioning (28) is provided between the separator piston (12) and the accumulator housing (10), which end-position cushioning (28) has at least one gap (66, 72) that narrows as the motion of the separator piston (12) increases in the direction of its end position and in that way builds up a flow resistance, which inhibits the motion of the separator piston (12), and which is introduced as a recess (64, 78) into at least one of the adjacent end faces (30, 56) of the separator piston (12) and the accumulator housing (10).

The invention relates to a piston accumulator having an accumulator housing and a separator piston, which can be moved longitudinally in the accumulator housing and which separates two media spaces from each other.

One of the main tasks of hydraulic accumulators, such as piston accumulators, is to absorb certain volumes of pressurized fluids from a hydraulic system and return them to the system on demand. In addition to piston accumulators, bladder accumulators, diaphragm accumulators and also weight-loaded and spring-loaded accumulators are regularly used as hydraulic accumulators. Hydraulic accumulators of this type can be used to implement a wide range of tasks, such as energy accumulator, shock, vibration and pulsation damping, energy recovery (recuperation) and volume flow compensation.

DE 100 57 746 A1 discloses a hydraulic accumulator in the form of a piston accumulator, having an accumulator housing and having at least one gas space arranged therein as one media space and a fluid or liquid space as the other media space. Said media spaces are separated from one another by a piston-like separating element, wherein at least one of these media spaces can be filled with a pressure medium, such as hydraulic fluid, via a valve control unit having at least one switching valve, and can be at least partially drained by the latter during operation. In the known solution, the valve control unit is an integral part of a solid control block, which is connected to the end of the accumulator housing as part of the latter.

Particularly in the case of high dynamics in the operation of the piston accumulator and for rapidly emptying processes on the liquid end of the accumulator, the separator piston may hit the solid closing part of the accumulator housing in the form of the control block hard under the influence of the gas pilot pressure in one of the media spaces, i.e., at least during long-term operation of such a piston accumulator, damage to the accumulator housing and/or the separator piston is to be expected, which can reduce the service life of such hydraulic accumulators, with the result that they have to be replaced more frequently by new accumulators.

In the context of suspension cylinders of other types, such as hydropneumatic piston-cylinder arrangements (DE 10 2011 010 070 A1), it has already been suggested, for the purpose of damping the motion of the piston rod, to secure a plate-shaped partition wall body provided with a damping diaphragm as a damping device in a cylinder housing with a piston rod arranged for longitudinal motion therein; but even if this damping diaphragm is integrated directly into the piston of the piston rod, as also shown, the manufacturing effort and thus also the costs are increased in view of the additional valve technology to be introduced. It has also been shown that the constant choke cross-sections of the damping orifice cannot guarantee sufficient damping in every case for every operating condition.

Based on this prior art, the invention is based on the task of creating an improved piston accumulator solution that is functionally reliable in operation, can be implemented at low manufacturing costs and leads to good damping results even at high motion energies of the separator piston. A piston accumulator having the features of claim 1 in its entirety solves this problem.

Accordingly, an essential feature of the invention is that end-position cushioning is provided between the separator piston and the accumulator housing, which end-position cushioning has at least one gap that narrows as the motion of the separator piston increases in the direction of its end position and in that way builds up a flow resistance, which inhibits the motion of the separator piston and which is introduced as a recess in at least one of the adjacent end faces of the separator piston and the accumulator housing. The fluid flow throttled by means of the gap when the separator piston moves towards its lower stop position achieves a functionally reliable effective damping which has no equivalent in the prior art. As a result of the gap reduction, the motion of the separator piston in the direction of its stop position is increasingly damped as the flow resistance increases, so that an unintentional impact on the assigned parts of the accumulator housing are prevented even in the case of high motion dynamics for the separator piston.

In a particularly preferred embodiment of the piston accumulator according to the invention, provision is made for the gap to be an annular gap, which surrounds a media opening, which connects the interior of the one media space to the environment in a media-conveying manner, in particular to media-conveying components of a technical system, such as a hydraulic system. In this way, fluid, such as hydraulic oil, can be discharged centrally from the accumulator via the media opening, to centrally expose the separator piston and its sealing system to actuation and motion forces, which helps to relieve the sealing and guide band system of the separator piston. This is not only true during accumulator draining operations, but also plays a key role when high pressure fluid from a hydraulic system flows into the accumulator through the media opening in the lower liquid-conveying media space, pushing the separator piston upwards towards the gas supply in one media space as the gas preload increases. Preferably, the gap opens out in the direction of the media opening and is delimited by wall parts of the accumulator housing and/or the separator piston on the outer circumference. The annular gap, which can also be segmented circumferentially into partial areas, in that way permits the fluid to flow out of the piston accumulator unhindered in the direction of the media opening, which is conducive to an improved damping effect.

Preferably, provision is made for the gap width to be constant when the separator piston hits the end stop at the adjacent accumulator housing, wherein the gap is delimited by adjacent end wall parts extending in parallel to each other, of the separator piston and of the accumulator housing. In this way, relatively large volumes of fluid can be discharged from the accumulator via the gap without causing high thermal compression stress on the fluid.

However, it is particularly preferred in a piston accumulator according to the invention that the gap width decreases continuously in the direction of the media opening. In this way, the motion of the separator piston to its lower stop position results in an increasing gap width reduction, which produces particularly good damping values that dampen the motion of the separator piston in a progressive manner, whereas a constant gap width tends to result in a linear damping behavior.

Preferably, the gap is formed as a recess in the end wall of the separator piston, wherein it is also possible to form the recess in the end wall of the accumulator housing adjacent to the separator piston or, if possible, to mirror-symmetrically provide a gap recess both in the separator piston and in the accumulator housing at their adjacent end walls.

To achieve a defined stop behavior of the separator piston, which is conducive to optimizing the flow behavior of the fluid out of the gap, provision is preferably made for the piston parts of the separator piston, while limiting the gap in at least one of its end position positions, in particular in the form of the lower end position, to come into abutment with the accumulator housing on the outer circumference and/or inner circumference. A possible inner circumferential stop for the separator piston can be provided with openings that connect the gap recess to the media opening in the accumulator, for fluid to flow out of the other media space, throttled in this way, as part of the damping device.

It has also been found advantageous to provide the separator piston with a pin-like extension on its free end face facing the media opening, which extension dips into the media opening as part of the end-position cushioning when it becomes effective. This extension can be used to provide further throttling of the fluid flow, starting from the respective gap recess, in the direction of the media opening, leading to improved damping results.

In a particularly preferred embodiment of the piston accumulator according to the invention, provision is made for the continuously decreasing gap size to be at least partially formed from a cone in the separator piston. In particular, the convex design of the gap course results in harmonious flow behavior and undesirable cavity phenomena during operation of the accumulator are avoided in the area of the gap reduction in any case.

From the point of view of production technology, it has proved advantageous to make provision in a piston accumulator for the accumulator housing to be formed at least from a, preferably cylindrical, housing wall and from a, preferably cylindrical, closing part, which has the media connection and is preferably screwed/bolted into the housing wall. In this way, a reliably functioning piston accumulator with reliable end-position cushioning can be achieved using few components in a simple manufacturing process. It is also of particular importance for the solution according to the invention that when the separator piston approaches its lower stop position, in which it rests, for instance, on the outer bearing ring of the housing cover, the liquid-conveying bore in the housing cover is not closed in any case, i.e., it remains open for liquid to be able to flow undisturbed from the gap-shaped damping space into the oil-end connecting bore.

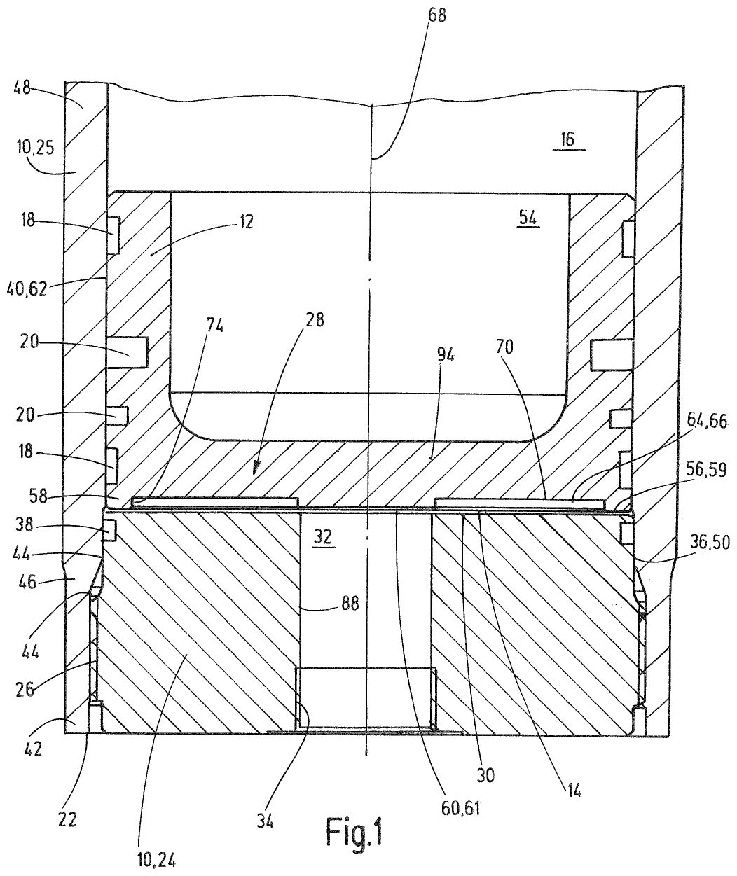

The piston accumulator according to the invention will be described below in greater detail by way of the exemplary embodiments shown in FIGS. 1 to 6.

FIG. 1 shows a longitudinal section of the lower part of a first exemplary embodiment of a piston accumulator according to the invention in one of its operating positions. The piston accumulator has a separator piston 12 that can be moved longitudinally in a cylindrical accumulator housing 10, which separates, as viewed in the direction of FIG. 1, a lower media space 14 from an upper media space 16. The one upper media space 16 is used to store a working gas, such as nitrogen gas, whereas the other lower media space 14 is used to hold a liquid, in particular in the form of hydraulic oil.

Such piston accumulators are readily available on the market in a variety of embodiments, so that their design will be discussed in detail only insofar as it relates to the invention. The separator piston 12 is provided with guide bands 18 and sealing ring arrangements 20, and can be longitudinally moved in the accumulator housing 10 in its shown operating installation position, and thus it can be moved upwards and downwards. The cylindrical accumulator housing 10 is closed at the top in a media-tight manner, for instance in a manner as shown in generic DE 100 57 746 A1. In the area of its bottom opening 22, the accumulator housing 10 is closed by means of a cylindrical closing part 24, which is inserted into the housing wall 25, in particular screwed into the lower end of the accumulator housing 10 via a threaded section 26, via the bottom opening 22. Furthermore, the solution according to the invention has end-position cushioning 28, which ensures that in the case of, in particular rapid downward motions of the separator piston 12, the latter is braked and, in particular an impact of the separator piston 12 on the closing part 24, which can cause material damage, is prevented.

On its end face 30 facing the separator piston 12, the closing part 24 is designed as a plane boundary wall, which on the inner circumference opens out into a media opening 32 without any protrusions, which media opening 32, designed as a central fluid duct in the longitudinal direction of the accumulator housing 10, connects the lower media space 14 to parts of a hydraulic system not shown in greater detail. For this purpose, the fluid channel 32 has an internal thread 34 at its lower outlet point for the purpose of connecting such a fluid line or liquid line of the hydraulic system. On the outer circumference, the planar boundary wall 30 of the closing part 24 merges into a cylindrical abutment wall 36, which holds a sealing ring 38 at its head end, which sealing ring 38 is in sealing engagement with the inner wall of the accumulator housing 10. At the foot end, the male thread 26 of the closing part 24 adjoins the abutment wall 36 as part of the threaded section 26.

Starting from the threaded section 26, formed by the male thread of the closing part 24 and the assigned female thread of the accumulator housing 10, which threaded section 26 is arranged at the thinnest point 42 of the accumulator housing 10 in its lower area, the wall thickness of the accumulator housing 10 increases step-by-step 44, wherein a medium wall thickness 46 is reached in the area of the adjacent abutment wall 36 of the closing part 24, and the wall thickness area 48 having the maximum wall thickness forms at the inner circumference the running surface for the separator piston 12 in this lower area. The transition point from the medium 46 to the largest 48 wall thickness area forms an annular limiting surface 50, which defines the maximum engagement area of the closing part 24 in the accumulator housing 10, wherein, as shown, the limiting wall 30 of the closing part 24 does not necessarily has to come into contact with the rounded tapered contact surface 50 of the accumulator housing 10.

The separator piston 12, which is provided with a recess 54 to increase the usable gas volume, has an outer delimiting ring 58 and an inner cylindrical, spigot-like protruding contact area 60 at its lower end 56. The outer circumference of the delimiting ring 58 transitions integrally into the outer guide wall 62 of the separator piston 12, and its free end face 59 lies in the plane of the free end face 61 of the cylindrical contact area 60, which in turn is an integral part of the separator piston 12 and is arranged in parallel to the limiting wall 30 of the closing part 24 in every travel position of the separator piston 12.

The outer diameter of the delimiting ring 58 is slightly smaller than the outer diameter of the closing part 24 in the area of its cylindrical abutment wall 36, to achieve an optimum, gentle force application when the separator piston 12 is placed on the closing part 24. The outer diameter of the cylindrical contact area 60 is again selected to be somewhat larger than the free diameter of the media opening 32, or central channel, such that during the placement described above, the counterpart closing part 24 provides a central support during the application of force. Between the outer delimiting ring 58 and the inner contact area 60, a recess 64 of constant depth is made in the free, downwards directed end wall 56 of the separator piston 12, which recess 64 forms an annular gap 66 in the separator piston 12 that extends concentrically to the longitudinal axis 68 of the accumulator housing 10 and is part of the end-position cushioning 28.

When the recess 64 is inserted into the separator piston 12, the outer delimiting ring 58 and the inner cylindrical, connector-like contact area 60, which are in contact with the adjacent, flat boundary wall 30 of the closing part 24 when the separator piston 12 is in its lowest position of travel, remain free-standing. In the direction of this lowest travel position, the delimiting ring 58 passes over the transition between the medium 46 and maximum 48 wall thickness area of the accumulator housing 10 as viewed in the axial direction in parallel to the longitudinal axis 68 of the accumulator housing 10. The recess 64 in the form of the annular space, which is constant in terms of the receiving volume, has a bottom 70 formed by the separator piston 12, which extends in a plane manner, in parallel to the free end faces 59, 61 of the delimiting ring 58 and of the contact area 60.

If the separator piston 12 moves downwards when liquid is taken from its liquid end 14 under the preload pressure of the working gas 16, which can occur dynamically at correspondingly high speeds, a gap opening formed by the adjacent wall parts of the closing part 24 and the cylindrical contact area 60 narrows increasingly, resulting in the increasing build-up of a flow resistance, which, in terms of end-position cushioning, inhibits the motion of the separator piston 12 in the direction of the closing part 24, which is correspondingly also fostered by the recess 64 in the separator piston 12 and any material-fatiguing impacts of the separator piston 12 on the stationarily arranged closing part 24 of the accumulator housing 10 as part thereof is prevented.

This throttling process via the free gap opening is shown in FIG. 1, before the separator piston 12 possibly assumes its lower contact position with the closing part 24 of the accumulator housing 10. When the downward motion is completed and the separator piston 12 is in contact with the closing part 24, a residual amount of liquid remains in the annular recess 64 as part of the annular gap in the separator piston 12, which then forms a kind of hydrodynamic bearing, which permits an unrestricted, cavitation-free flow of liquid in the opposite direction from the media opening 32, as soon as, under an increased liquid pressure with simultaneous increase in the gas preload, the separator piston 12 lifts off from the closing part 24 of the accumulator housing 10, i.e., as viewed in the direction of view of FIG. 1, it moves into an upper operating position.

In an embodiment not shown, it is also possible to introduce at least one throttle bore into the cylindrical contact area 60 of the separator piston 12, one free end of which opens into the media opening 32 when the separator piston 12 is in contact, and the other free end of which opens into the annular space of the recess 64 in the separator piston 12 and in that way is part of a changing gap geometry.

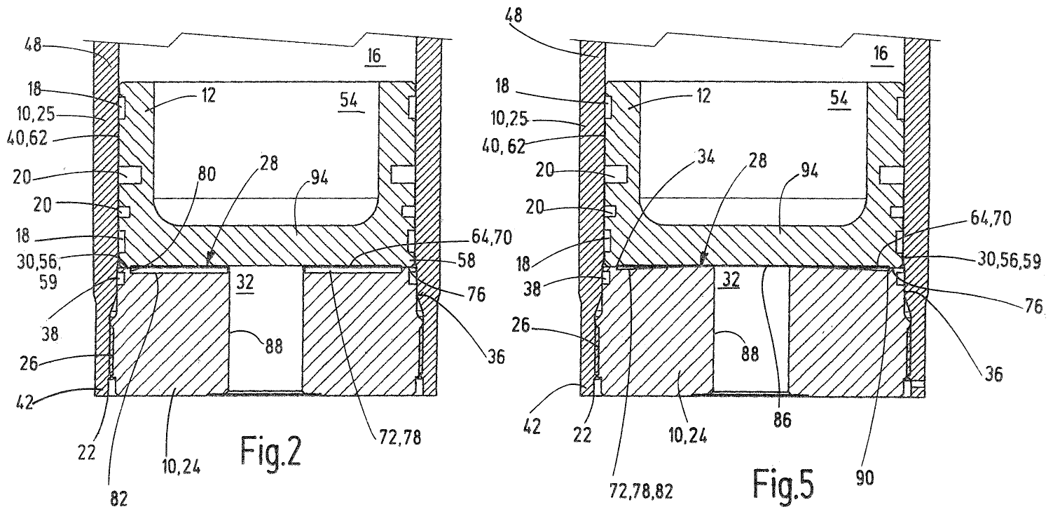

FIG. 2 shows a longitudinal section of the lower part of a second exemplary embodiment of the piston accumulator according to the invention in its lower end position, which differs from the first embodiment of FIG. 1 as follows:

A recess 64 of constant depth, encompassed by the outer delimiting ring 58, is made in the downwardly directed end wall 56 of the separator piston 12, forming a disk-shaped cylindrical gap 66 in the separator piston 12, which is part of the end-position cushioning 28. The gap 66 is delimited in the radial direction by the radially inner sidewall 74 of the outer delimiting ring 58 and is concentric with the longitudinal axis 68 of the accumulator housing 10. The recess 64 in the separator piston 12 has a bottom 70 formed by the separator piston 12, which bottom 70 extends plane and in parallel to the free end face 59 of the outer delimiting ring 58 of the separator piston 12.

The closing part 24 has at its upper end 30, as viewed in the radial direction, a further outer delimiting ring 76, which is coaxial with the longitudinal axis 68 of the piston accumulator and the free end face 30 of which lies in a notional plane oriented perpendicular to the longitudinal axis 68 of the piston accumulator. The further outer delimiting ring 76 integrally transitions into the outer abutment wall 36 of the closing part 24 at the outer circumference. An annular recess 78 of constant depth is inserted in the upwardly directed end wall 30 of the closing part 24, enclosed by the further outer delimiting ring 76, which recess 78 forms a disk-shaped cylindrical gap 72 in the closing part 24, which gap 72 is part of the end-position cushioning 28. The disk-shaped gap 72 is delimited in the radial direction by the radially inner side wall 80 of the further outer delimiting ring 76 of the closing part 24, which is aligned with the radially inner side wall 74 of the outer delimiting ring 58 of the separator piston 12. The recess 78 in the closing part 24 has a bottom 82 formed by the closing part 24, which bottom 82 extends in a planar manner, in parallel to the free end face 30 of the further outer delimiting ring 76 and transitions into the fluid channel 32 in a radially inwards direction without any protrusions.

The recess 64 of the separator piston 12 has a smaller depth compared to the recess 78 of the closing part 24.

In the lower end position of the separator piston 12 shown in FIG. 2, only the end faces 30, 59 facing each other, of the delimiting rings of the separator piston 12 and the closing part 24 are in contact with each other, wherein the recesses 64, 78 of the separator piston 12 and the closing part 24 remain spaced apart. As a result, the overall disk-shaped gap 66, 72 formed in the lower end position of the separator piston 12 by the recesses 64, 78 in the separator piston 12 and by the closing part 24, is permanently connected to the fluid channel 32 in a fluid-conveying manner.

In this way, when the liquid end 14 of the accumulator is emptied with simultaneous downward motion of the separator piston 12, a rapid fluid flow results in this area, which leads to a negative pressure in the inwardly open gap 66, 72, which on the one hand accelerates the downward motion of the separator piston 12, but on the other hand also entrains more or less dispersed gas components in the liquid, which due to their compressible behavior would otherwise prevent effective damping.

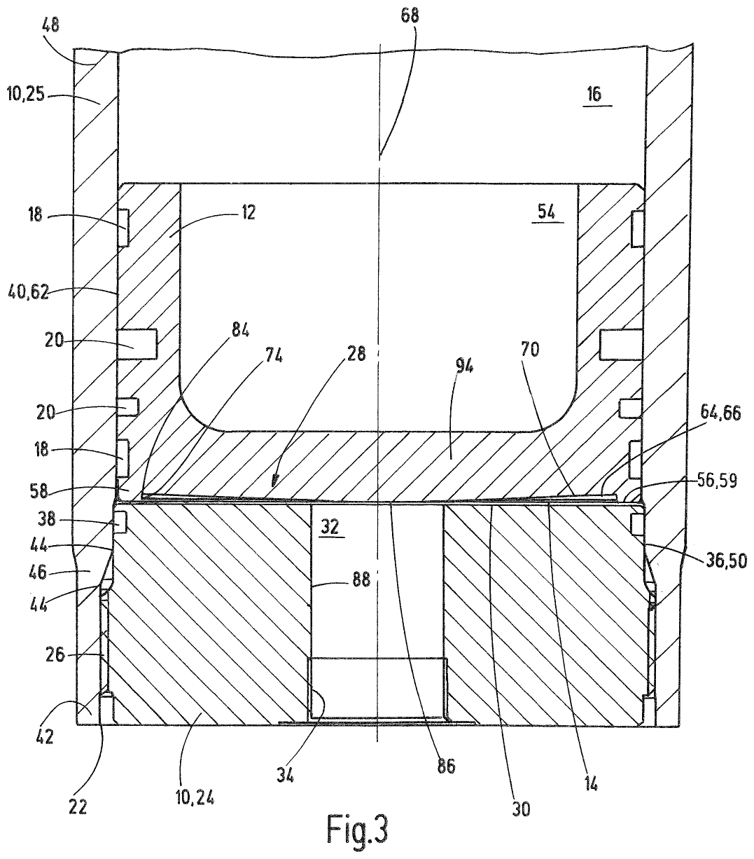

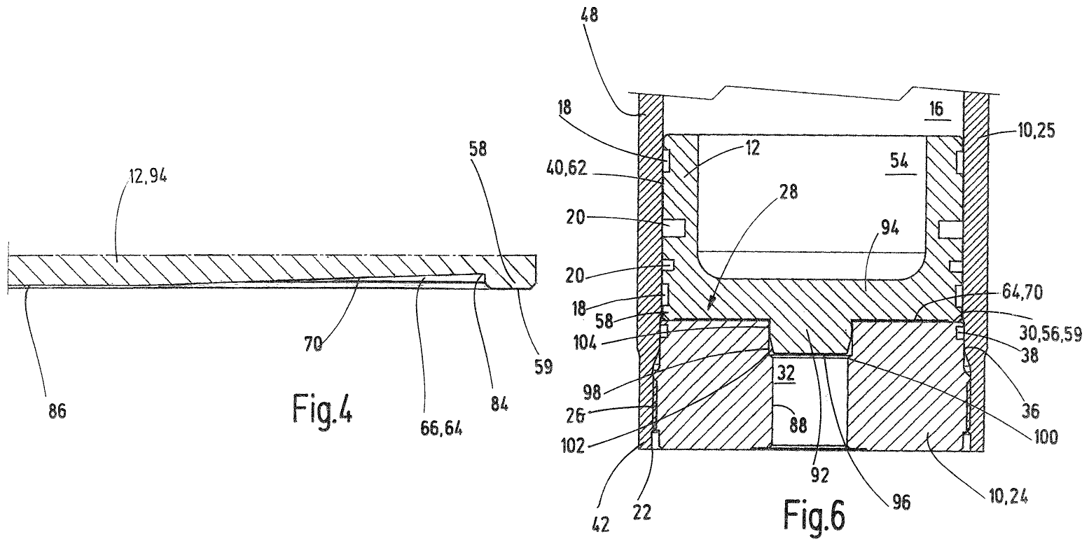

FIG. 3 shows a longitudinal section of the lower part of a third exemplary embodiment of the piston accumulator according to the invention in one of its operating positions. FIG. 4 shows a partial longitudinal section of the separator piston 12 of the third exemplary embodiment of the piston accumulator of FIG. 3 in the area of its recess 64. The third exemplary embodiment of the piston accumulator differs from the first embodiment of FIG. 1 as follows:

A frustoconical recess 64, encompassed by the outer delimiting ring 58, is inserted in the downwardly directed end wall 56 of the separator piston 12, wherein said recess 64 forms a corresponding gap 66 in the separator piston 12, which gap 66 is part of the end-position cushioning 28. The recess 64 has its maximum depth directly adjacent to the radially inner side wall 74 of the outer delimiting ring 58 of the separator piston 12 in the area of a linear and circular rim 84 in the transition between the radially inner side wall 74 of the outer delimiting ring 58 and the bottom 70 of the recess 64. The recess 64 has its minimum depth in the area of a central and planar circular surface 86, which is concentrically aligned with the longitudinal axis 68 of the piston accumulator and arranged in a notional plane perpendicular to the longitudinal axis 68. Formed in this way, in the axial direction towards the closing part 24, the outer delimiting ring 58 of the separator piston 12 projects beyond the central circular surface 86, which in turn projects beyond the circular rim 84 at the transition between the bottom 70 of the recess 64 and the radially inner side wall 74 of the outer delimiting ring 58. Starting from the rim 84 in the transition between the bottom 70 of the recess 64 and the radially inner side wall 74 of the outer delimiting ring 58, the bottom 70 of the recess 64 extends in the direction of the closing part 24 and the longitudinal axis 68 of the piston accumulator with a constant pitch tapered towards the central circular surface 86 and merges into the latter.

FIG. 3 shows the piston accumulator in a state in which the separator piston 12 is slightly spaced apart from the closing part 24. When the separator piston 12 moves in the direction of the closing part 24, a slight throttling occurs in this state—just as in the first exemplary embodiment according to FIG. 1—while a flow resistance across the free gap width is established, effecting an end-position cushioning 28.

The diameter of the central circular surface 86 is smaller than the inner diameter of the fluid channel 32 of the closing part 24, so that only the outer delimiting ring 58 of the separator piston 12, which is arranged in its lower end position, is in contact with the flat end face 30 of the closing part 24, wherein the separator piston 12 is spaced apart from the closing part 24 in the area of its recess 64. As a result, the gap 66, which in the lower end position of the separator piston 12 is co-delimited by the recess 64 in the separator piston 12 and the end face 30 of the closing part 24, is permanently connected to the fluid channel 32 in a fluid-conveying manner. Starting from its radially outer end, the gap 66 tapers, viewed in longitudinal section, in a wedge-shaped manner in the direction of the fluid channel 32 due to its sloping upper end.

FIG. 5 shows a longitudinal section of the lower part of a fourth exemplary embodiment of the piston accumulator according to the invention in its lower end position, which differs from the third exemplary embodiment of FIG. 3 as follows:

In addition to the frustoconical recess 64 in the downwardly directed end wall 56 of the separator piston 12, the closing part 24 has at its upper end, as viewed in the radial direction, a further outer delimiting ring 76, which is oriented coaxially with the longitudinal axis 68 of the piston accumulator and the free end face 30 of which lies in a notional plane oriented perpendicular to the longitudinal axis 68 of the piston accumulator. The radially inner side wall 80 of the further outer delimiting ring 76 is aligned with the radially inner side wall 74 of the delimiting ring 58 of the separator piston 12. The further outer delimiting ring 76 integrally transitions into the outer abutment wall 36 of the closing part 24 at the outer circumference. The end facing the lower media space 14, of the wall 88 of the fluid channel 32 extends in the axial direction up to the notional plane, in which the end face 30 of the further outer delimiting ring 76 is located. Between the further outer delimiting ring 76 and the end facing the lower media space 14, of the wall 88 of the fluid channel 32, a conically tapering recess 78 is inserted in the upwardly directed end wall 30 of the closing part 24, wherein the recess 78 forms a corresponding annular gap 72, which is part of the end-position cushioning 28. The recess 78 has its maximum depth directly adjacent to the radially inner side wall 80 of the further outer delimiting ring 76 of the closing part 24 in the area of a linear and circular rim 90 in the transition between the radially inner side wall 80 of the further outer delimiting ring 76 and the bottom 82 of the recess 78. The recess 78 has its minimum depth directly adjacent to the end facing the lower media space 14, of the wall 88 of the fluid channel 32. Starting from the rim 90 in the transition between the radially inner side wall 80 of the further outer delimiting ring 76 and the bottom 82 of the recess 78, the bottom 82 of the recess 78 extends in the direction of the separator piston 12 and of the longitudinal axis 68 of the piston accumulator, tapering with a constant pitch, to the end facing the lower media space 14, of the wall 88 of the fluid channel 32, into whose inner wall the bottom 82 transitions.

The maximum depth of the recess 78 of the closing part 24 is greater than the maximum depth of the recess 64 of the separator piston 12.

When the separator piston 12 is arranged in its lower end position, as shown in FIG. 5, solely its outer delimiting ring 58 is in contact with the further outer delimiting ring 76 of the closing part 24, wherein the separator piston 12 in the area of its recess 64 is spaced apart from the closing part 24. As a result, the co-delimited overall gap 66, 72 formed in the lower end position of the separator piston 12 by the recesses 64, 78 in the separator piston 12 and the closing part 24, is permanently connected to the fluid channel 32 in a fluid-conveying manner. Starting from its radially outer end, as viewed in longitudinal section, the gap 66, 72 tapers in a wedge-shaped manner in the direction of the fluid channel 32 due to its sloping upper and lower end.

It has been shown that this conical double gap arrangement results in very good damping properties under high thermal stress, because the fluid thermally stressed by the motion of the separator piston 12 equally allows heat to be transferred in both directions, i.e., to the separator piston 12 and to the closing part 24 of the accumulator housing 10.

FIG. 6 shows a longitudinal section of the lower part of a fifth exemplary embodiment of the piston accumulator according to the invention in its lower end position, which differs from the first exemplary embodiment of FIG. 1 as follows:

The constant depth recess 64 in the downwardly directed end 56 of the separator piston 12 is provided between the outer delimiting ring 58 and a central extension 92 in the form of a downwardly protruding pin-like projection. The central projection 92 protrudes in the axial direction from the outer delimiting ring 58. Preferably, the axial height of the central projection 92 is approximately equal to the axial wall thickness of the bottom 94 of the separator piston 12. The free end face 96 of the central projection 92 is formed as a flat circular surface and lies in a notional plane oriented perpendicular to the longitudinal axis 68 of the piston accumulator. The central projection 92, viewed in the axial direction, is cylindrical between the bottom 70 of the recess 64 of the separator piston 12 and its central area, whereupon the central projection 92 tapers from its central area towards its planar free end face 96.

For moving the central projection 92 of the separator piston 12 into and out of the closing part 24, the fluid channel 32 of the closing part 24 is formed in such a way that its inner diameter in an end area facing the lower media space 14 widens in the direction of the lower media space 14, forming a conically widening intermediate area 100. The axial height of the inner diameter extension 98 of the fluid channel 32 is greater than the axial distance between the end face 59 of the outer delimiting ring 58 of the separator piston 12 and the free end face 96 of the central projection 92. As a result, when the separator piston 12 is arranged in its lower end position, in which the outer delimiting ring 58 of the separator piston 12 is in contact with the flat end face 30 of the closing part 24 in the sense of a stop, the free end face 96 of the central projection 92 is arranged at a distance from the conically widening intermediate area 100 of the fluid channel 32 of the closing part 24 in the axial direction, forming a gap. In addition, the radial width of the inner diameter extension 98 of the fluid channel 32 forming a gap is greater than the largest outer diameter of the central projection 92.

This results in different effective gap ranges for the end-position cushioning 28. When the separator piston 12 is in its lower end position, as shown in FIG. 6, the gap 66 co-delimited by the recess 64 of the separator piston 12 and the planar end face 30 of the closing part 24 is connected in a fluid-conveying manner to the gap co-delimited by the outer circumference 102, 104 of the central projection 92 of the separator piston 12 and the inner circumference of the fluid channel 32 in the area of its inner circumferential extension 98, which in turn is connected in a fluid-conveying manner to the fluid channel 32 via the gap formed between the central projection 92 and the conically widening intermediate area 100 of the fluid channel 32.

When the separator piston 12, which is arranged at a distance from the closing device 24, moves in the direction of the closing device 24, the tapered peripheral end area 102 of the central projection 92 initially dips into the fluid channel 32 in the area of its inner circumferential extension 98. During this motion, the gap between the outer circumference 102 of the central projection 92 and the inner circumference of the fluid channel 32 increasingly narrows in the area of its inner circumferential widening 98 due to the tapered lateral circumferential area 102 of the central projection 92, such that the discharge of the amount of fluid from the gap areas is throttled in a progressively increasing manner. This results in a progressively increasing damping effect of the motion of the separator piston 12. The strongest throttling is achieved when the cylindrical circumferential end area 104 of the central projection 92 plunges into the fluid channel 32 in the area of its inner circumferential extension 98.

In this way, large quantities of fluid can first be discharged from the gap 66 between the separator piston 12 and the accumulator housing 24 within the framework of constant throttling, without impairing the dynamics of the separator piston motion, in order to then be able to perform the material-protecting end-position cushioning 28 in a progressive manner while maintaining the dynamics. Hydraulic accumulators or piston accumulators designed for this purpose can be used without difficulty for hydraulic systems subject to high dynamic loads.

1. A piston accumulator having an accumulator housing (10) and a separator piston (12), which can be moved longitudinally in the accumulator housing (10) and separates two media spaces (14, 16) from each other, characterized in that an end-position cushioning (28) is provided between the separator piston (12) and the accumulator housing (10), which end-position cushioning (28) has at least one gap (66, 72) that narrows as the motion of the separator piston (12) increases in the direction of its end position and in that way builds up a flow resistance, which inhibits the motion of the separator piston (12), and which is introduced as a recess (64, 78) into at least one of the adjacent end faces (30, 56) of the separator piston (12) and the accumulator housing (10).

2. The piston accumulator according to claim 1, characterized in that the gap (66, 72) is an annular gap, which surrounds a media opening (32), which connects the interior of a media space (14) to the environment in a media-conveying manner, in particular to media-conveying components of a technical system, such as a hydraulic system.

3. The piston accumulator according to claim 1, characterized in that the gap (66, 72) opens out in the direction of the media opening (32) and is delimited on the outer circumference by wall parts of the accumulator housing (10) and/or of the separator piston (12).

4. The piston accumulator according to claim 1, characterized in that, when the separator piston (12) hits the end stop at the adjacent accumulator housing (10), the gap width is constant and in that the gap (66, 72) is delimited by adjacent end wall parts (30, 56) extending in parallel to each other, of the separator piston (12) and the accumulator housing (10).

5. The piston accumulator according to claim 1, characterized in that the gap width decreases continuously in the direction of the media opening (32).

6. The piston accumulator according to claim 1, characterized in that the gap (66, 72) is introduced as a recess (64, 78) in the end wall (30, 56) of the separator piston (12) and the accumulator housing (10).

7. The piston accumulator according to claim 1, characterized in that the separator piston (12), while limiting the gap (66, 72) in at least one of its end positions, comes into abutment with the accumulator housing (10) with piston parts on the outer circumference and on the inner circumference.

8. The piston accumulator according to claim 1, characterized in that the separator piston (12) has a pin-like extension (92) on its free end face (56) facing the media opening (32), which extension (92) dips into the media opening (32) as part of the end-position cushioning (28) when it becomes effective.

9. The piston accumulator according to claim 1, characterized in that the continuously decreasing gap size is at least partially formed from a cone in the separator piston (12).

10. The piston accumulator according to claim 1, characterized in that the accumulator housing (10) is formed at least from a, preferably cylindrical, housing wall (25) and from a, preferably cylindrical, closing part (24), which comprises the media opening (32) and is preferably screwed into the housing wall (25).
